(19) United States
(12) Patent Application Publication
(10) Pub. No.: US 2005/0269109 A1
(43) Pub. Date: Dec. 8, 2005

(54) Method of extinguishing fires

(76) Inventor: James Q. Maguire, Norman, OK (US)

Correspondence Address: DUNLAP, CODDING & ROGERS P.C., PO BOX 16370, OKLAHOMA CITY, OK, 73113, US

(21) Appl. No.: 10/958,789

(22) Filed: Oct. 5, 2004

Related U.S. Application Data
(60) Provisional application No. 60/576,286, filed on Jun. 3, 2004.

(51) Int. Cl. A62C 2/00; A62C 3/00

(52) U.S. Cl. 169/43; 169/45; 169/46; 169/47

(57) ABSTRACT

Methods for extinguishing fires, such as house fires, forest fires, brush fires and grass fires are disclosed which include the step of applying an effective amount of liquid nitrogen on the fire to extinguish the fire and to cool the burning materials to a temperature below the re-ignition temperature of such materials. For house fires, a minor effective amount of liquid oxygen can be mixed with liquid nitrogen to enhance recovery of individuals trapped in the burning house.

### CROSS-REFERENCE TO RELATED APPLICATIONS

This application claims benefit of U.S. Provisional Application 60/576,286, filed Jun. 2, 2004, which is incorporated herein by reference in its entirety.

### STATEMENT REGARDING FEDERALLY SPONSORED RESEARCH OR DEVELOPMENT

Not applicable.

### BACKGROUND OF THE INVENTION

1. Field of the Invention

The present invention relates to methods for extinguishing fires, and more particularly but not by way of limitation, to methods for extinguishing building fires, wild fires including fires fueled by forest, brush or grassland vegetation, and gas or oil fires, by injecting liquid nitrogen onto the fire to replace air containing oxygen and cool the burning materials below their re-ignition temperatures.

2. Brief Description of Related Art

For a fire to occur, there must be available oxygen, a supply of fuel, and enough heat to kindle the fuel. Therefore, the three basic ways of extinguishing a fire are: to smother it, to cut off the fuel supply, or to cool the fuel below the flammability temperature.

The firefighting strategy will depend somewhat on the supply of fuel as well as the location of the fire. Generally, to battle wild fires (which include forest fires, brush fires and grass fires), firefighters use airplanes to apply chemicals from the air and trucks and pumps to apply water at the ground level. In addition, the firefighters attempt to remove vegetation surrounding the fire to create a border that lacks fuel. As one can appreciate, the destruction caused by a wild fire, as well as the effectiveness of firefighters in extinguishing them, depends on the terrain, the type of vegetation in the area, weather conditions and availability of firefighting resources.

Similar problems occur in fighting other types of fires such as building fires and oil and gas fires. Water, although supplanted somewhat by other materials, is the most common substance used for quenching building fires. Subsequently, many of the buildings constructed today are protected against fire most effectively by protective sprinkler systems. In most sprinkler systems, water circulates through overhead pipes whose outlets are normally closed. When a certain temperature is reached, the outlets open and water is sprayed onto the fire. In addition, most large buildings also provide water for fighting fires through a standpipe system with hose connections on each floor.

Generally, oil and gas fires can not be fought with water unless it is sprayed in a fine mist because flammable liquids will usually float on water and spread. Thus, the prior art system for combating oil and gas fires has generally consisted of applying a foam to the fire so as to suffocate the fire.

While many advances have been made in methods and compositions for extinguishing various types of fire, new and improved methods are constantly being sought, especially when such methods are capable of not only extinguishing the fire, but also preventing re-ignition of the fuel or material once the fire has been extinguished. It is to such methods that the present invention is directed.

### BRIEF DESCRIPTION OF THE DRAWINGS

FIG. 1 is a pictorial representation of a liquid nitrogen truck injecting liquid nitrogen or a low volume oxygen/liquid nitrogen mixture into a burning house to extinguish a fire.

FIG. 2 is a pictorial representation of a land based truck dispersing liquid nitrogen onto a forest fire to extinguish the fire.

FIG. 3 is a pictorial representation of a helicopter dispensing liquid nitrogen onto a forest fire to extinguish the fire.

### DETAILED DESCRIPTION OF THE DRAWINGS

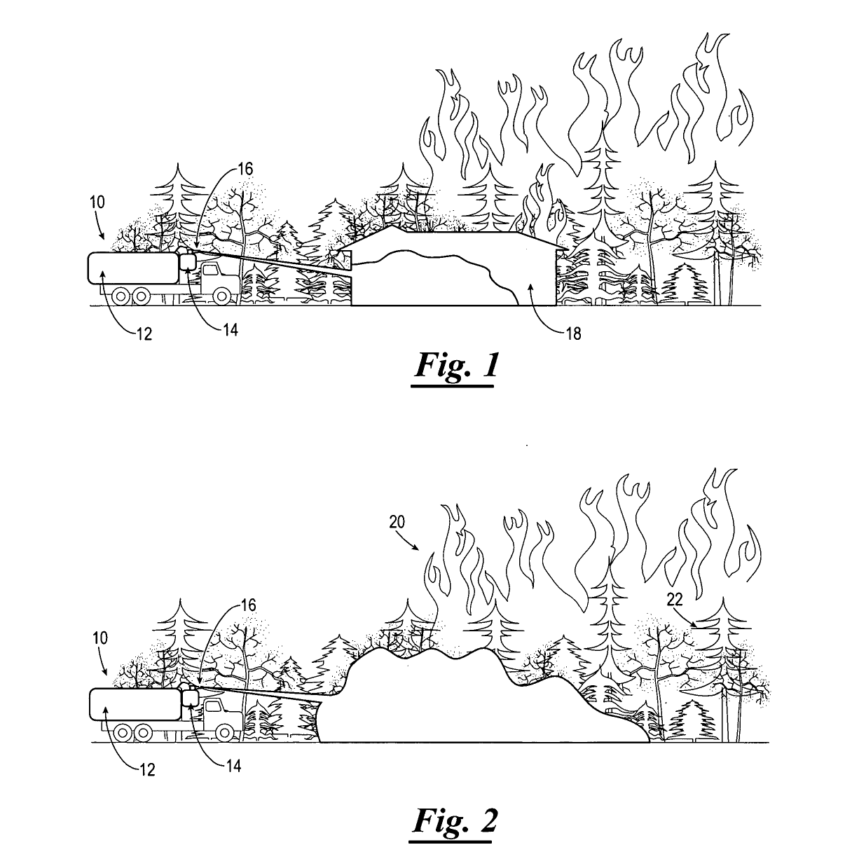

Referring now to the drawings, and more particularly to FIGS. 1 and 2, shown therein and identified by the numeral 10, is a liquid nitrogen truck. The liquid nitrogen truck 10 includes a cryogenic tank 12 containing liquid nitrogen, a cryogenic pump 14, such as a high pressure centrifugal cryogenic pump, operably connected to and in fluid communication with the liquid nitrogen in the cryogenic tank 12, and a high pressure nozzle 16 for dispensing liquid nitrogen, or a low volume oxygen mixed with liquid nitrogen, from the cryogenic tank 12 upon activation of the cryogenic pump 14.

To extinguish a fire of a burning structure, such as a house 18 (FIG. 1) or to extinguish a forest fire 20 (FIG. 2) utilizing the liquid nitrogen truck 10, the liquid nitrogen truck 10 is positioned at a location relative to an inhabitable structure, such as the house 18 (shown in FIG. 1) or the forest fire 20 consisting of a plurality of burning trees 22 (shown in FIG. 2) such that liquid nitrogen and/or a mixture of low volume oxygen/liquid nitrogen can be effectively discharged from the cryogenic tank 12 via the high pressure nozzle 16 upon activation of the cryogenic pump 14. By injecting liquid nitrogen and/or a mixture of low volume oxygen and liquid nitrogen into a inhabitable structure, such as the house 18, air containing oxygen is replaced by the liquid nitrogen and thus combustion is halted. As will be described in further detail hereinafter, not only is the combustion halted, but by applying an effective amount of liquid nitrogen to cool the house 18 below the combustible temperature of the materials constituting the house 18, the fire will not be rekindled once the liquid nitrogen has evaporated and dissipated. Further, when employing the method of the present invention where liquid nitrogen is injected into a inhabitable structure, such as a house 18 to extinguish a fire, it may be desirable to admix a low volume of oxygen with the liquid nitrogen so as to provide sufficient oxygen (i.e., about 9 volume percent) within the house 18 to support life, if any individuals are in the house 18, and at the same time, permit the firefighters to more safely enter the house 18 because the amount of oxygen present in the liquid nitrogen is insufficient to permit re-ignition of the fire.

To extinguish fires in remote locations, such as the forest fires 20, brush fires or grass fires, it may be desirable to employ an aircraft, such as a helicopter 24 equipped with a cryogenic tank 26 containing liquid nitrogen, a cryogenic pump 28, such as a high pressure centrifugal cryogenic pump, and a high pressure nozzle 30. The high pressure nozzle 30 and the cryogenic pump 28 are in fluid communication with the cryogenic tank 26 such that upon activation of the cryogenic pump 28 liquid nitrogen is discharged via the high pressure nozzle 30 onto the burning trees 22 and thus extinguishes the forest fire 20. It should be noted that while the helicopter 24 has been shown discharging liquid nitrogen onto the forest fire 20, the helicopter 24 can also be used to extinguish fires in structures, such as the house 18 (FIG. 1) or high rise structures such as office buildings and apartment buildings.

In the practice of the present invention, large volumes of liquid nitrogen can be contained in much smaller volumes in the liquid stage. A standard cubic foot (SCF) of liquid nitrogen contains 696 SCF at standard conditions of 60° F. and 14.7 psi. At a temperature of 2000° F., such as when a standard cubic foot (SCF) of liquid nitrogen is sprayed on a fire, the volume of the liquid nitrogen increases to 3400 SCF. This expansion will drive out the oxygen feeding the fire and the hot combustion gases of smoke. The result is a cessation of combustion due to lack of oxygen. In addition, subsequent volumes of liquid nitrogen at a temperature of about −320° F. will cool the previous burning materials and prevent re-ignition of such materials.

Thus, liquid nitrogen provides an effective method for extinguishing fires in inhabitable structures such as the house 18, wild land fires, such as the trees 22 of the forest fires 20 and grass fires, as well as industrial fires, and oil and gas fires. Further, the use of the liquid nitrogen eliminates water damage that normally occurs from fighting fires with water. For example, the injection of liquid nitrogen into a burning structure such as the house 18 will result in a rapid expansion of the nitrogen where it reaches its crucial temperature of −320° F. In such occurrence, the expansion is so rapid that it would amount to an explosion. The explosion will drive out any air containing oxygen and replace it with pure non-burning nitrogen. As previously stated, when utilizing liquid nitrogen to extinguish house fires, it is desirable to use liquid nitrogen containing low volumes of oxygen so that humans can breathe, but the combustion can not be sustained, in order to save persons who may be trapped in the burning house 18 and to allow firefighters to safely enter the house 18 during a rescue operation.

It is known that combustion ceases if the oxygen content falls below 13%. The injection of liquid nitrogen after vaporization will reduce the oxygen content to near 0%. The subsequent mixing of new air at 21% oxygen with 0% nitrogen will result in a mixture twice the original volume of nitrogen and will contain only 10½% oxygen, an amount below that which is necessary for combustion.

For example, if the house 18 has 3,000 square feet in area, with a ceiling of 8 feet, the house 18 contains 24,000 cubic feet of volume. If on fire, with the average temperature having risen to 2,000° F., an injection of 36 gallons of liquid nitrogen will vaporize, expand rapidly and drive out all the heat, smoke and combustion gases.

The rapid vaporization of liquid nitrogen referred to as “Rapid Phase Transition” or RPT can result in a significant explosion. Therefore, the injection of liquid nitrogen should be carefully controlled. It is a significant feature of the invention and differs greatly from just injecting vaporized nitrogen onto a fire.

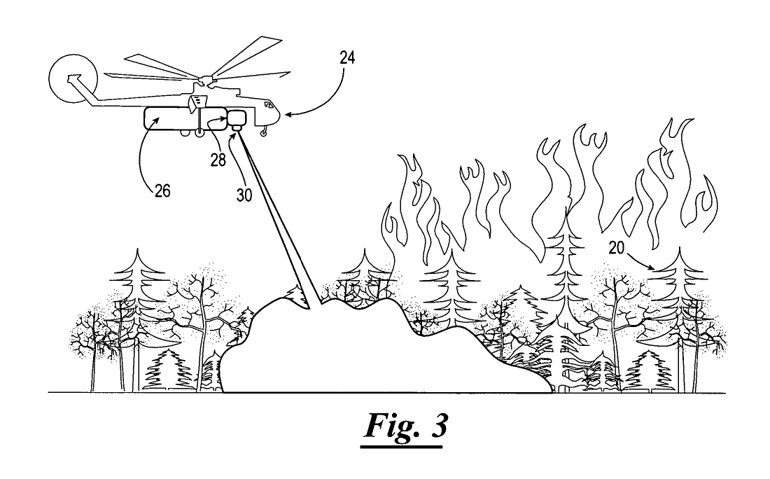

The method of the present invention can be used to put out large forest fires 20 and grass fires. If used with the land based truck 10 equipped with the cryogenic tank 12 (FIG. 2) or the helicopter 24 equipped with the cryogenic tank 26 (FIG. 3), significant volumes of liquid nitrogen can be injected into the forest fire 20 using high pressure centrifugal cryogenic pumps capable of pumping at a rate of 400 gallons per minute. These injections would be on a continuous basis. The explosions that will occur from RPT will help drive out any oxygen.

To illustrate this process to treat forest fires 20, consider injecting into a burning front whose dimensions are a ½ sphere of 50 foot diameter. If the temperature of the burning front is 3,000° F., then a gallon of liquid nitrogen, after vaporization, will expand to 628 cubic feet. (A SCF will expand to 4,700 SCF).

A burning front consisting of a ½ sphere of 50 foot diameter will contain ½ ( 4/3 Π r³)=32,725 SCF. To replace this with nitrogen requires 52 gallons of liquid nitrogen for each 50 foot diameter section, or 106—50 foot diameter sections per mile, or 5,500 gallons of liquid nitrogen per mile.

A small fire demonstration which will be described later, indicated that an initial volume of liquid nitrogen would immediately put out a fire but after a one or two minute interval, new oxygen would re-ignite the fire if the fuel, i.e. the material burning, was still above the combustion temperature. The same fire demonstration indicated that if additional volumes of liquid nitrogen, on the order of three to four times the volume needed to suppress combustion, were injected that the combustible material would reach temperatures well below 0° F.

The result of this fire demonstration indicates that fire suppression by itself is not the answer, but rather re-combustion must be prevented by reducing the temperature of the burning material below its re-combustion temperature.

In view of this, the volume of liquid nitrogen required to put out forest fires 20 or grass fires may be three to four times the suppression volume of 5,500 gallons of liquid nitrogen per mile or perhaps 20,000 gallons per mile. At 75 cents per gallon for liquid nitrogen, the cost per mile would be about $15,000, plus the cost of the helicopter 24 or the truck 10.

If trucks can be used, a smaller volume of liquid nitrogen may be required if used in conjunction with water trucks. The liquid nitrogen would suppress the fire and the water could be used for cooling.

### EXAMPLE

As for the fire demonstration, a tin washtub was filled with newspapers and wood branches. The fire was ignited and allowed to burn vigorously before a small volume of liquid nitrogen was poured on the tub. As soon as the first volume of liquid nitrogen hit the tub, the fire went out immediately and stayed out for approximately two minutes. It then re-ignited and burned profusely as new oxygen from the atmosphere hit the tub and slowly increased the oxygen level.

After two attempts with the same volume of liquid nitrogen, a third fire was started and allowed to burn profusely. A volume of liquid nitrogen three to four times the original volume was applied. Not only did re-combustion not occur, but using an electronic temperature gauge on some of the branches showed a temperature of −31° F. ten minutes after injection and the bottom four inches of the tub was encased in frozen moisture.

The above described experiments are consistent in principal to an open fire such as would occur in forest fires. When applied to house fires, the closed structures would restrict the amount of new oxygen that could enter. Even if some of the previously burning material was still above the combustion temperature, re-ignition would not occur because of the lack of sufficient oxygen, particularly since the oxygen content must be above 13% to enable re-ignition of the material.

Undiluted liquid nitrogen can be used in all forest or grass fires. However, in circumstances involving house fires, where humans may be trapped inside, liquid air is mixed with the liquid nitrogen in an amount that the oxygen content will be increased to about 9%. This will permit humans to breathe but would still be below the combustion point of 13% oxygen.

With the ability to put out fire instantaneously, firefighters can quickly enter the house 18 carrying their own oxygen and additional oxygen masks for fire victims.

From the above description it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

1. A method for extinguishing fires, the method comprising the step of:
applying an effective amount of liquid nitrogen onto burning material to extinguish the fire and cool the material to a temperature below the combustible temperature of the material.

2. The method for extinguishing fires according to claim 1 wherein the effective amount of liquid nitrogen applied to the burning material is further characterized as an amount sufficient such that, upon vaporization of the liquid nitrogen, the oxygen content present in and surrounding the material is approximately 0 percent.

3. The method of extinguishing fires according to claim 2 wherein the burning material is a plurality of burning trees and wherein the effective amount of liquid nitrogen applied to the burning trees is from about 3 to about 4 times the amount of liquid nitrogen required to extinguish the fire.

4. The method of extinguishing fires according to claim 3 wherein the amount of liquid nitrogen employed to extinguish the plurality of burning trees is about 5,500 gallons of liquid nitrogen per frontal mile of trees.

5. The method for extinguishing fires according to claim 1 wherein the burning material is grass.

6. The method for extinguishing fires according to claim 1 wherein the burning material is a building.

7. The method of extinguishing fires according to claim 1 wherein the burning material is a plurality of burning trees and wherein the amount of liquid nitrogen applied to the burning trees is about 5,500 gallons of liquid nitrogen per frontal mile of trees.

8. A method for extinguishing a fire in a structure comprising the step of:
applying an effective amount of liquid nitrogen containing a minor amount of oxygen onto a burning structure to extinguish the fire and to cool the structure, the minor amount of oxygen present in the liquid nitrogen being an amount sufficient to support life but insufficient to support re-ignition of the structure.

9. The method of claim 8 wherein the minor amount of oxygen present in the liquid nitrogen is an amount sufficient to provide the liquid nitrogen with about 9 percent oxygen.

10. The method of claim 8 wherein the amount of liquid nitrogen containing oxygen applied to the burning structure is an amount sufficient such that upon applying the liquid nitrogen containing the oxygen to the burning structure, combustion ceases due to lack of oxygen and the level of oxygen is maintained at a level of less than about 13 percent for a period of time to prevent re-ignition of the structure.

11. A method for extinguishing fires, the method comprising the step of:
providing a truck having a cryogenic tank containing liquid nitrogen, a cryogenic pump in fluid communication with the cryogenic tank and a high pressure nozzle;
positioning the truck at a location relative to the burning material so that the truck is in position to discharge liquid nitrogen onto the fire resulting from the burning material;
activating the cryogenic pump whereby an effective amount of liquid nitrogen is discharged onto the fire via the high pressure nozzle to extinguish the fire and cool the burning material to a temperature below the combustible temperature of the material.

12. The method for extinguishing fires according to claim 11 wherein the effective amount of liquid nitrogen discharged onto the fire is further characterized as an amount sufficient such that, upon vaporization of the liquid nitrogen, the oxygen content present in or surrounding the fire is approximately 0 percent.

13. The method of extinguishing fires according to claim 12 wherein the burning material is a plurality of burning trees and wherein the effective amount of liquid nitrogen applied to the plurality of burning trees is from about 3 to about 4 times the amount of liquid nitrogen required to extinguish the fire.

14. The method of extinguishing fires according to claim 13 wherein the amount of liquid nitrogen employed to extinguish fire produced by the burning of the plurality of trees is about 5,500 gallons of liquid nitrogen per frontal mile of trees.

15. The method for extinguishing fires according to claim 11 wherein the burning material is grass.

16. The method for extinguishing fires according to claim 11 wherein the burning material is a building.

17. The method of extinguishing fires according to claim 11 wherein the burning material is a plurality of burning trees and wherein the amount of liquid nitrogen applied to the plurality of burning trees is about 5,500 gallons of liquid nitrogen per frontal mile of the trees.

18. A method for extinguishing a fire in an inhabitable structure comprising the step of:
providing a truck having a cryogenic tank containing liquid nitrogen, a cryogenic pump in fluid communication with the cryogenic tank and a high pressure nozzle;
positioning the truck at a location relative to the inhabitable structure so that the truck is in position to discharge liquid nitrogen onto the inhabitable structure to extinguish the fire;
activating the cryogenic pump whereby liquid nitrogen is discharged from the high pressure nozzle; and
applying an effective amount of liquid nitrogen containing a minor amount of oxygen onto the burning inhabitable structure to extinguish the fire and cool the inhabitable structure to a temperature below its combustible temperature, the minor effective amount of oxygen present in the liquid nitrogen being an amount sufficient to support life but insufficient to support re-ignition of the inhabitable structure.

19. The method of claim 18 wherein the minor amount of oxygen present in the liquid nitrogen is an amount sufficient to provide the liquid nitrogen with about 9 percent oxygen.

20. The method of claim 18 wherein the amount of liquid nitrogen containing oxygen applied to the burning inhabitable structure is an amount sufficient such that upon applying the liquid nitrogen containing the oxygen to the burning inhabitable structure, combustion ceases due to lack of oxygen and the level of oxygen is maintained at a level of less than about 13 percent for a period of time to prevent re-ignition of the inhabitable structure.

21. A method for extinguishing fires, the method comprising the step of:
providing a helicopter having a cryogenic tank containing liquid nitrogen, a cryogenic pump in fluid communication with the cryogenic tank and a high pressure nozzle;
positioning the helicopter at a location relative to a fire so that the helicopter is in position to discharge liquid nitrogen onto the fire; and
activating the cryogenic pump whereby an effective amount of liquid nitrogen is discharged onto the fire via the high pressure nozzle to extinguish the fire and cool the burning material to a temperature below the combustible temperature of the material.

22. The method for extinguishing fires according to claim 21 wherein the effective amount of liquid nitrogen discharged onto the fire is further characterized as an amount sufficient such that, upon vaporization of the liquid nitrogen, the oxygen content present in or surrounding the fire is approximately 0 percent.

23. The method of extinguishing fires according to claim 22 wherein the burning material is a plurality of burning trees and wherein the effective amount of liquid nitrogen applied to the burning trees is from about 3 to about 4 times the amount of liquid nitrogen required to extinguish the fire.

24. The method of extinguishing fires according to claim 23 wherein the amount of liquid nitrogen employed to extinguish the plurality of burning trees is about 5,500 gallons of liquid nitrogen per frontal mile of trees.

25. The method for extinguishing fires according to claim 21 wherein the burning material is grass.

26. The method for extinguishing fires according to claim 21 wherein the material is a building.

27. The method of extinguishing fires according to claim 21 wherein the material is a plurality of burning trees and wherein the amount of liquid nitrogen applied to the burning trees is about 5,500 gallons of liquid nitrogen per frontal mile of the trees.

28. A method for extinguishing a fire in an inhabitable structure comprising the step of:
providing a helicopter having a cryogenic tank containing liquid nitrogen, a cryogenic pump in fluid communication with the cryogenic tank and a high pressure nozzle;
positioning the helicopter at a location relative to the inhabitable structure so that the helicopter is in a position to discharge liquid nitrogen onto the inhabitable structure to extinguish the fire; and
activating the cryogenic pump so that high pressure liquid nitrogen is discharged from the high pressure nozzle; and
applying an effective amount of liquid nitrogen containing a minor amount of oxygen onto its combustible material, the minor amount of oxygen present in the liquid nitrogen being an amount sufficient to support life but insufficient to support re-ignition of the inhabitable structure.

29. The method of claim 28 wherein the minor amount of oxygen present in the liquid nitrogen is an amount sufficient to provide the liquid nitrogen with about 9 percent oxygen.

30. The method of claim 28 wherein the amount of liquid nitrogen containing oxygen applied to the inhabitable structure is an amount sufficient such that upon applying the liquid nitrogen containing the oxygen to the burning inhabitable structure, combustion ceases due to lack of oxygen and the level of oxygen is maintained at a level of less than about 13 percent for a period of time to prevent re-ignition of the inhabitable structure.
